(19) United States
(12) Patent Application Publication
(10) Pub. No.: US 2014/0145497 A1
(43) Pub. Date: May 29, 2014

(54) CONNECTIBLE WHEEL RIM STRUCTURE FOR A BICYCLE

(71) Applicant: Bin Chang, Taichung City (TW)

(72) Inventor: Bin Chang, Taichung City (TW)

(21) Appl. No.: 13/735,023

(22) Filed: Jan. 6, 2013

(30) Foreign Application Priority Data
Nov. 23, 2012 (TW) 101222814

(51) Int. Cl. B60B 25/02

(52) U.S. Cl. CPC B60B 25/02
USPC 301/95.102; 301/95.11

(57) ABSTRACT

A connectible wheel rim structure for a bicycle includes a wheel rim body and a plurality of metal connectors. The wheel rim body has a plurality of sub wheel rims. Each sub wheel rim has an assembling groove defined thereon to assemble with a bicycle tire.

Each sub wheel rim has an annular portion and a channel defined thereon. Two ends of each metal connector are respectively inserted into the channel of each corresponding sub wheel rim and the channel of adjacent sub wheel rim, so that the sub wheel rims are closely assembled with each other via the metal connectors. Under this arrangement, the structural strength of the wheel rim body is enhanced; hence, the wheel rim body does not detach easily because of the metal connectors, so that a user rides the bicycle stably and safely.

### BACKGROUND OF THE INVENTION

1. Field of the Invention

The present invention relates to a wheel rim structure, and more particularly to a connectible wheel rim structure for a bicycle.

2. Description of Related Art

A conventional connectible wheel rim comprises a wheel rim body which comprises a plurality of sub wheel rims. Each sub wheel rim has a male junction extruded and a female junction defined at one end and another end thereof respectively. A shape of the male junction corresponds to another shape of the female junction. The wheel rim body has a frame portion and a receiving portion defined at a lower portion and an upper portion thereof respectively. The frame portion is made of composite materials. The receiving portion is made of high strength aluminum alloys so as to attach to a tire. The female junction of one sub wheel rim closely sleeves on the male junction of an adjacent sub wheel rim, such that the sub wheel rims are connected with each other so as to form the conventional connectible wheel rim. The flatness and the roundness of the conventional connectible wheel rim are further improved by fixtures. Under this arrangement, a rider rides the bicycle stably because of a better structural strength of the conventional connectible wheel rim.

However, the conventional connectible wheel rim has a disadvantage described as following.

When the conventional connectible wheel rim suffers too much force, the male junction becomes frail and breakable easily, so that the sub wheel rims cannot form as the conventional connectible wheel rim anymore.

The present invention has arisen to mitigate and/or obviate the disadvantages of the conventional.

### SUMMARY OF THE INVENTION

The main objective of the present invention is to provide a wheel rim structure.

To achieve the objective, a connectible wheel rim structure for a bicycle comprises a wheel rim body and a plurality of metal connectors, the wheel rim body comprising a plurality of sub wheel rims, each sub wheel rim having an assembling groove defined along one periphery thereof so as to assemble with a bicycle tire, each sub wheel rim having an annular portion defined along another periphery thereof, each sub wheel rim has a channel opened therethrough, two ends of each metal connector being respectively inserted into the channel of each corresponding sub wheel rim and the channel of adjacent sub wheel rim, one end of one sub wheel rim closely abutting against another end of adjacent sub wheel rim, the sub wheel rims closely assembled with each other via the metal connectors so as to form the connectible wheel rim structure for a bicycle. Wherein, each metal connector is arc-shaped which matches with a shape of the channel; the metal connectors are securely assembled with the channels; at least three metal connectors are applied in the connectible wheel rim structure for a bicycle; the number of the metal connectors is the same as the number of the sub wheel rims; a distance between two adjacent metal connectors equals to another distance between another two adjacent metal connectors; a shape of the channel corresponds to an outline of the sub wheel rim; each metal connector .has two assembling portions extruded thereof so that one sub wheel rim is closely assembled with another sub wheel rim via the metal connector; wherein the structural strength of the assembling groove of each sub wheel rim is enhanced because of the two assembling portions; the wheel rim body is made of carbon fiber, and the metal connectors are made of aluminum alloys.

Under this arrangement, the structural strength of the wheel rim body is enhanced and the wheel rim body does not detach easily because of the metal connectors.

Further benefits and advantages of the present invention will become apparent after a careful reading of the detailed description with appropriate reference to the accompanying drawings.

### BRIEF DESCRIPTION OF THE DRAWINGS

FIG. 1 is a partial perspective view of a connectible wheel rim structure for a bicycle of the present invention;

FIG. 2 is a partial exploded view of the connectible wheel rim structure for a bicycle;

FIG. 3 is a radially cross-sectional view of the connectible wheel rim structure for a bicycle;

FIG. 4 is a partial enlarged view of FIG. 3;

FIG. 5 is an axially cross-sectional view of the connectible wheel rim structure for a bicycle; and

FIG. 6 is a cross-sectional view of a second embodiment of the connectible wheel rim structure for a bicycle.

### DETAILED DESCRIPTION OF THE INVENTION

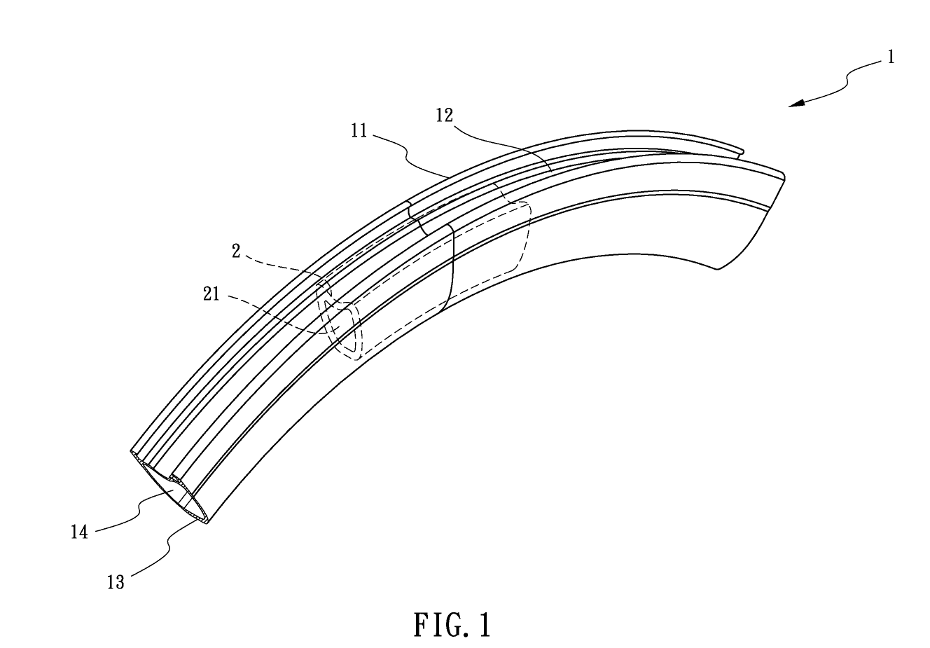

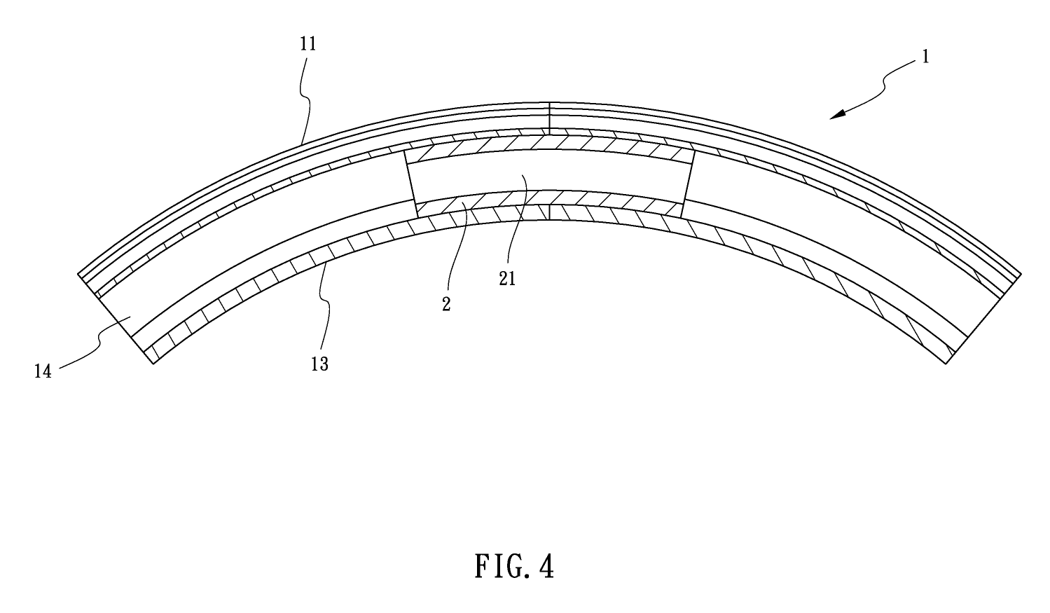

Referring to FIGS. 1-4, a connectible wheel rim structure for a bicycle in accordance with a first embodiment of the present invention comprises a wheel rim body 1 and a plurality of metal connectors 2.

The wheel rim body 1 comprises a plurality of sub wheel rims 11. Each sub wheel rim 11 has an assembling groove 12 defined along one periphery thereof so as to assemble with a bicycle tire (not shown). Each sub wheel rim 11 has an annular portion 13 defined along another periphery thereof. Each sub wheel rim 11 has a channel 14 opened therethrough.

Two ends of each metal connector 2 are respectively inserted into the channel 14 of each corresponding sub wheel rim 11 and the channel 14 of adjacent sub wheel rim 11 with one end of one sub wheel rim 11 closely abutting against another end of adjacent sub wheel rim 11. Therefore, the sub wheel rims 11 are closely assembled with each other via the metal connectors 2 so as to form the connectible wheel rim structure for a bicycle.

Under this arrangement, the structural strength of the wheel rim body 1 is enhanced and the wheel rim body 1 does not detach easily because of the metal connectors 2, so that a user rides the bicycle assembled with the present invention stably and safely.

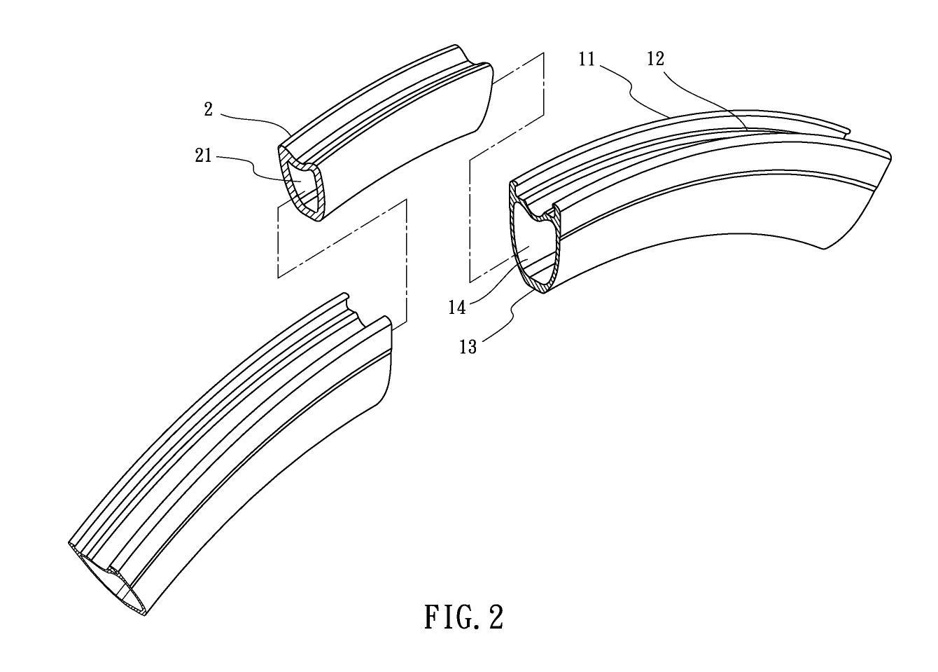

Referring to FIG. 2 and FIGS. 5-6, each metal connector 2 is arc-shaped which matches with a shape of the channel 14, so that one sub wheel rim 11 is closely assembled with adjacent sub wheel rim 11 and forms a circle-shaped. Therefore, the sub wheel rims 11 are closely assembled with each other because the metal connectors 2 are securely assembled with the channels 14, so that the structural strength of the wheel rim body 1 is enhanced and the wheel rim body 1 cannot be break easily.

In order to achieve a weight reduction, the wheel rim body 1 is made of carbon fiber, and the metal connectors 2 are made of aluminum alloys which are rather rigid. Besides, each metal connector 2 has a through hole 21 opened therein. The through hole 21 of each metal connector 2 communicates with the channels 14 of each corresponding two sub wheel rims 11. Therefore, the weight of the present invention is reduced because of the through hole 21 and the structural strength is enhanced because the metal connectors 2 are made of aluminum alloys.

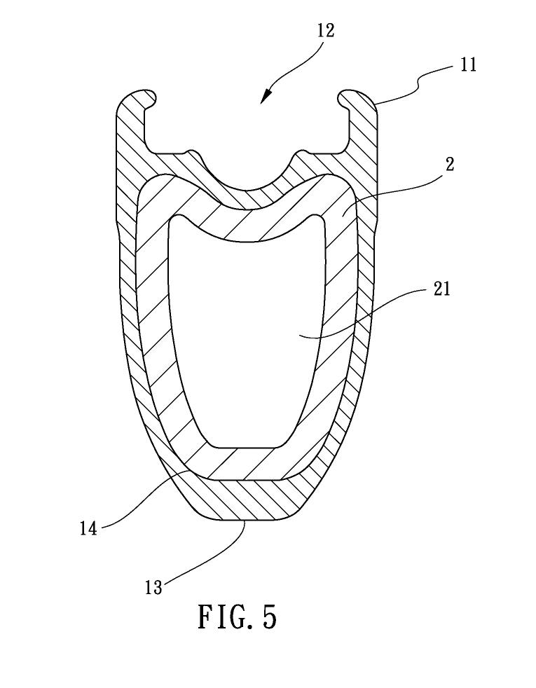

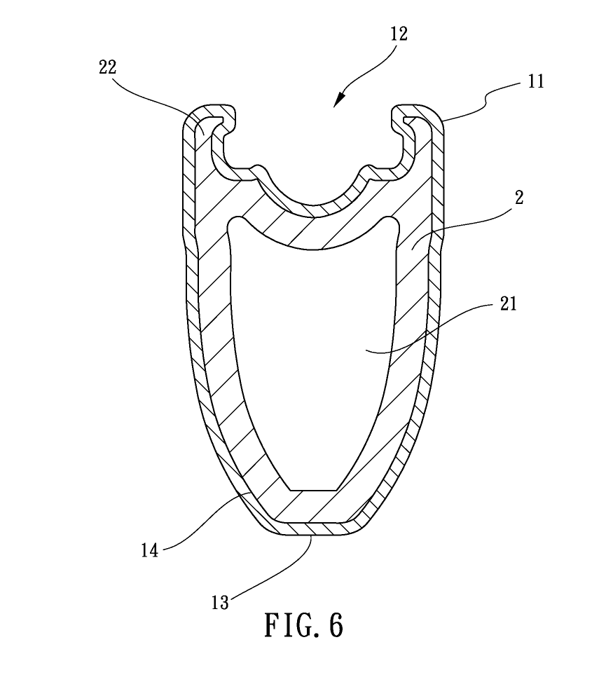

For adapting to different kinds of bicycles, structural enhancements are applied at different portions of the wheel rim body 1. Referring to FIG. 5, the structural enhancement is emphasized at an inner portion of each sub wheel rim 11. In contrast, referring to FIG. 6, a second embodiment of the present invention, which shows the structural enhancement is emphasized at the assembling groove 12 of each sub wheel rim 11 (Only the differences between the first embodiment and the second embodiment are further described.). A shape of the channel 14 corresponds to an outline of the sub wheel rim 11. Each metal connector 2 has two assembling portions 22 extruded thereof so that one sub wheel rim 11 is closely assembled with another sub wheel rim 11 via the metal connector 2. Under this arrangement, the structural strength of the assembling groove 12 of each sub wheel rim 11 is enhanced because of the two assembling portions 22.

The details of the present invention are further described as following.

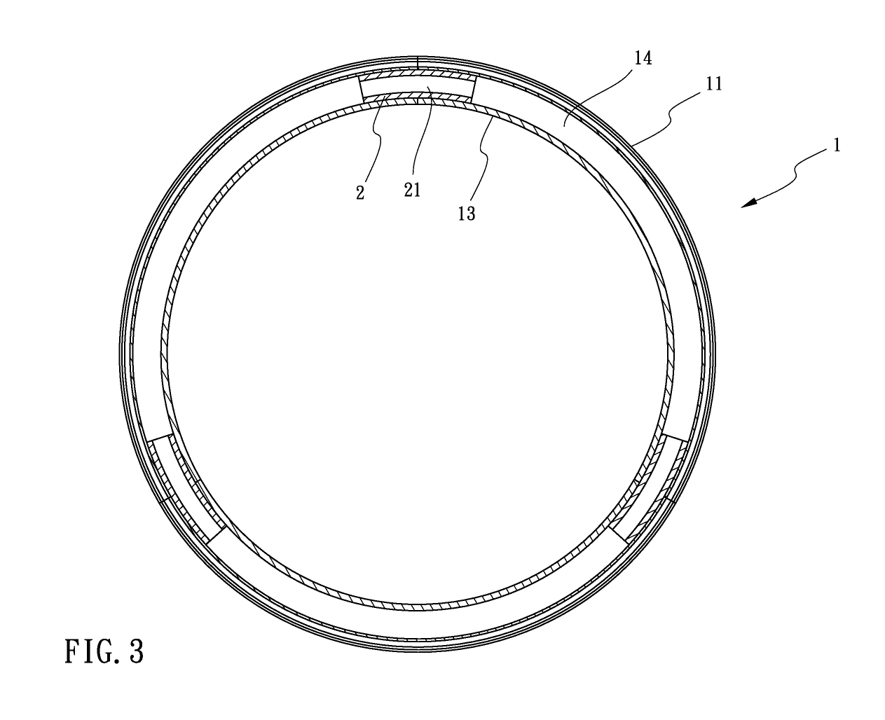

Referring to FIG. 3, at least three metal connectors 2 are applied in the present invention. The number of the metal connectors 2 is the same as the number of the sub wheel rims 11. A distance between two adjacent metal connectors 2 equals to another distance between another two adjacent metal connectors 2.

Although the invention has been explained in relation to its preferred embodiment, it is to be understood that many other possible modifications and variations can be made without departing from the spirit and scope of the invention as hereinafter claimed.

What is claimed is:

1. A connectible wheel rim structure for a bicycle comprising a wheel rim body and a plurality of metal connectors;
the wheel rim body comprising a plurality of sub wheel rims, each sub wheel rim having an assembling groove defined along one periphery thereof so as to assemble with a bicycle tire, each sub wheel rim having an annular portion defined along another periphery thereof, each sub wheel rim has a channel opened therethrough; and
two ends of each metal connector being respectively inserted into the channel of each corresponding sub wheel rim and the channel of adjacent sub wheel rim, one end of one sub wheel rim closely abutting against another end of adjacent sub wheel rim, the sub wheel rims closely assembled with each other via the metal connectors so as to form the connectible wheel rim structure for a bicycle;
wherein the structural strength of the wheel rim body is enhanced and the wheel rim body does not detach easily because of the metal connectors.

2. The connectible wheel rim structure for a bicycle as claimed in claim 1, wherein each metal connector is arc-shaped which matches with a shape of the channel; the metal connectors are securely assembled with the channels.

3. The connectible wheel rim structure for a bicycle as claimed in claim 1, wherein at least three metal connectors are applied in the connectible wheel rim structure for a bicycle; the number of the metal connectors is the same as the number of the sub wheel rims; a distance between two adjacent metal connectors equals to another distance between another two adjacent metal connectors.

4. The connectible wheel rim structure for a bicycle as claimed in claim 1, wherein a shape of the channel corresponds to an outline of the sub wheel rim; each metal connector has two assembling portions extruded thereof so that one sub wheel rim is closely assembled with another sub wheel rim via the metal connector; wherein the structural strength of the assembling groove of each sub wheel rim is enhanced because of the two assembling portions.

5. The connectible wheel rim structure for a bicycle as claimed in claim 1, wherein the wheel rim body is made of carbon fiber, and the metal connectors are made of aluminum alloys.
